(19) United States
(12) Patent Application Publication
(10) Pub. No.: US 2010/0306602 A1
(43) Pub. Date: Dec. 2, 2010

(54) SEMICONDUCTOR DEVICE AND ABNORMALITY DETECTING METHOD

(75) Inventors: Mamoru KAMIYA, Yokohama-shi (JP); Yoshinori HAZAKA, Yokohama-shi (JP)

Correspondence Address: JOSEPH PETRYSZAK, P O BOX 116, BRUCETON MILLS W, VA, 26525, US

(73) Assignee: NEC ELECTRONICS CORPORATION, Kawasaki (JP)

(21) Appl. No.: 12/787,812

(22) Filed: May 26, 2010

(30) Foreign Application Priority Data
May 28, 2009 (JP) 2009-128787

(51) Int. Cl. G06F 11/07

(52) U.S. Cl. 714/56; 714/E11.024; 714/55

(57) ABSTRACT

A semiconductor device comprises: a task state storage configured to store an executing state of a processing task of software executed by a CPU and to output an executing state signal to show the executing state of the processing task; a task validity judging section configured to acquire an interruption signal corresponding to the processing task based on a control of the CPU and the execution state signal, and to output a valid signal when the processing task is executed validly; a clear signal output section configured to output a clear signal in response to the valid signal; and a watchdog timer configured to clear a timer count value when the clear signal is acquired within a prescribed time and to output a reset signal when the clear signal is not acquired within the prescribed time.

### INCORPORATION BY REFERENCE

This application claims the benefit of priority based on Japanese Patent Application No. 2009-128787, filed on May 28, 2009, the disclosure of which is incorporated herein by reference.

### BACKGROUND OF THE INVENTION

1. Field of the Invention

The present invention relates to a semiconductor device and, more specifically, to a method of detection of abnormality in software.

2. Description of Related Art

Semiconductor integrated circuits have become large-scaled year by year and functions to be mounted thereon have become complicated. Thus, the semiconductor integrated circuits have come to use software such as a real-time OS (Operating System) to achieve efficient controls. However, with the semiconductor integrated circuits using the real-time OS, there are increased cases of having a continuous high-load state in which the real-time OS simultaneously controls the functions, which may cause unexpectable abnormality. Therefore, it is required for the semiconductor integrated circuits using the real-time OS to include capabilities of executing secure detection of abnormal states during the operation and executing adequate processing for the abnormality, and to operate stably.

A technique related to a digital processing device having software self-examining function is disclosed in Patent Literature 1. FIG. 1 is a block diagram showing a configuration of the digital processing device disclosed in Patent Literature 1. Referring to FIG. 1, the digital processing device includes an abnormality occurrence monitoring task 100 and abnormality occurrence monitoring means 110. The abnormality occurrence monitoring task 100 includes holding means 101, judging means 102, performance judging means 103, and alarm output means 104.

The holding means 101 receives operation state notifying information 121 of a processing task 120A and a processing task 120B. The judging means 102 judges whether or not the operation state notifying information 121 indicates a validity of the processing task 120A and the processing task 120B. When the judging means 102 judges that the tasks are in the validity, a counter 111 of the abnormality occurrence monitoring means 110 is cleared. When the judging means 102 judges that the tasks are in an abnormal state, the counter 111 is not cleared. When the counter 111 is cleared, the performance judging means 103 judges the performances of the processing task 120A and the processing task 120B. The alarm output means 104 outputs an alarm signal 123 corresponding to the performance judgment made by the performance judging means 103. Such digital processing device is capable of resetting a CPU 130 or generating an alarm when the processing task 120A or the processing task 120B exhibits the abnormality, even if the abnormality occurrence monitoring task 100 is operating validly.

### CITATION LIST

Patent Literature 1: JP-A-Heisei 8-202587

### SUMMARY OF THE INVENTION

However, as a result of conducting eager investigations, the inventors of the present invention have found that it is not possible to execute secure abnormality detections with the digital processing device of Patent Literature 1. First, execution timings will be described of the digital processing device disclosed in Patent Literature 1. FIG. 2 is a chart showing the execution timings of the digital processing device of Patent Literature 1, speculated by the inventors of the present invention. Referring to FIG. 2, the executions timings of the processing task 120A, the processing task 120B, and the abnormality occurrence monitoring task 100 are shown. Timing T1 shows an execution start timing of the processing task 120A, and timing T2 shows an execution end timing of the processing task 120A. Further, timing T3 shows an execution start timing of the processing task 120B, and timing T4 shows an execution end timing of the processing task 120B. It is assumed that the priority order is equal for the processing task 120A, the processing task 120B, and the abnormality occurrence monitoring task 100.

The processing task 120A and the processing task 120B as the processing tasks of the real-time OS provides the operation state notifying information 121 corresponding to the operation state to the abnormality occurrence monitoring task 100, when the processing ends (timing T2, timing T4). Upon acquiring the operation state notifying information 121, the abnormality occurrence monitoring task 100 executes following operations. In the abnormality occurrence monitoring task 100, the holding means 102 holds the operation state notifying information 121. The judging means 102 judges whether or not the operation is valid based on the operation state notifying information 121 held by the holding means 102. When the operation is valid, the counter 111 of the abnormality occurrence monitoring means 110 is cleared. Further, the performance judging means 103 makes judgment on the performance of the processing task 120A or the processing task 120B based on the count value of the counter 111 and the operation state notifying information 121, and the alarm output means 104 outputs an alarm signal 123 when there is an occurrence of abnormality.

The digital processing device disclosed in Patent Literature 1 is capable of detecting the abnormality of the processing task 120A and the processing task 120B at the execution timings shown in FIG. 2. However, there is a possibility that the digital processing device cannot detect the abnormality when the priority order of the processing task 120B is higher than that of the abnormality occurrence monitoring task 100 and the processing task 120B continues from timing T2 to timing T4. FIG. 3 is a chart showing execution timings of the digital processing device disclosed in Patent Literature 1, speculated by the inventors of the present invention. The abnormality occurrence monitoring task 100 cannot start up and detect the abnormality from timing T2 to timing T4, since the execution of the processing task 120B that has the higher priority order is started at timing T2. That is, there is an issue that the abnormality occurrence monitoring task 100 cannot detect the abnormality even when the counter 111 overflows at timing T6, until the task 100 starts up after timing T4 that is the execution end timing of the processing task 120B.

A semiconductor device of the present invention comprises: a task state storage configured to store an executing state of a processing task of software executed by a CPU and to output an executing state signal which shows the executing state of the processing task; a task validity judging section configured to acquire an interruption signal corresponding to the processing task based on a control of the CPU and the execution state signal, and to output a valid signal when the processing task is executed validly; a clear signal output section configured to output a clear signal in response to the valid signal; and a watchdog timer configured to clear a timer count value when the clear signal is acquired within a prescribed time and to output a reset signal when the clear signal is not acquired within the prescribed time.

An abnormality detecting method of the present invention comprises:

acquiring an interruption signal corresponding to a processing task of software executed by a CPU; outputting an execution state signal which shows an execution state of the processing task; judging whether or not the processing task is being executed validly based on the interruption signal and the execution state signal; outputting a valid signal when the processing task is executed validly; outputting a clear signal in response to the valid signal; judging whether or not the clear signal is acquired within a prescribed time; clearing a timer count value of a watchdog timer when the clear signal is acquired within the prescribed time; and outputting a reset signal to the CPU when the clear signal is not acquired within the prescribed time.

The semiconductor device of the present invention can securely detect the abnormality of the processing tasks executed by the software without imposing load on the CPU.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a configuration of a digital processing device disclosed in Patent Literature 1;

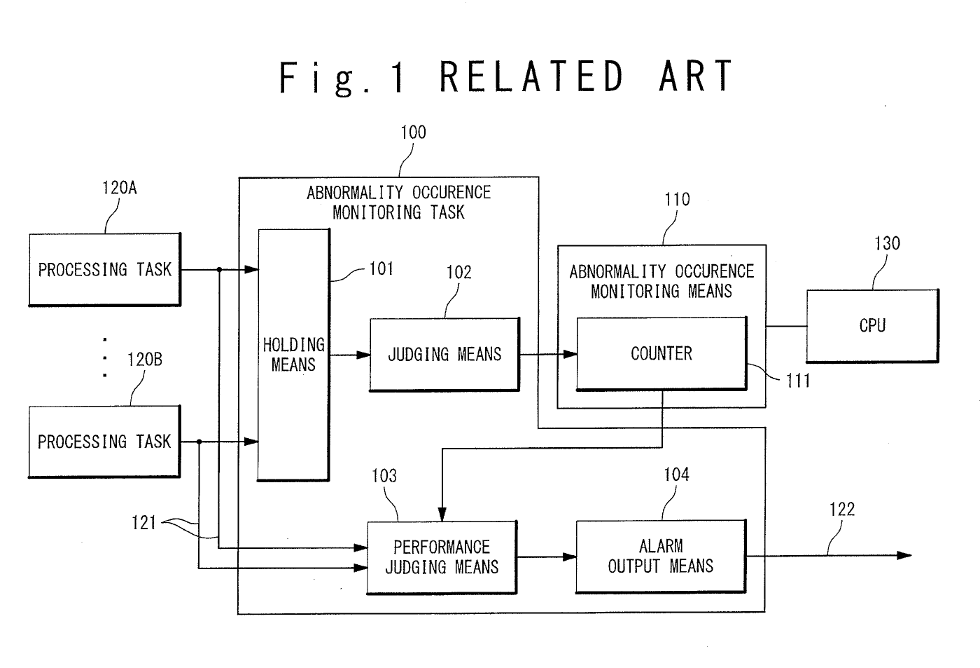

FIG. 2 is a chart showing execution timings of the digital processing device disclosed in Patent Literature 1, speculated by the inventors of the present invention;

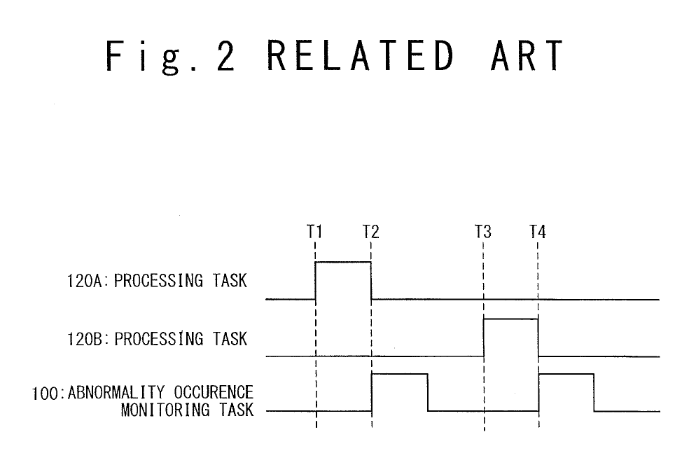

FIG. 3 is a chart showing execution timings of the digital processing device disclosed in Patent Literature 1, speculated by the inventors of the present invention;

FIG. 4 is a block diagram showing an example of the structure of an abnormality detecting section 1 that is a semiconductor integrated device according to a first embodiment of the present invention;

FIG. 5 is a chart showing timings of each signal when a processing task of software executed by a CPU 2 is executed validly;

FIG. 6 is a chart showing timings of each signal when a processing task after an interruption signal 201 is not executed validly;

FIG. 7 is a chart showing timings of each signal when a processing task does not end validly;

FIG. 8 is a chart showing timings of each signal when a processing task is started up even though there is no interruption signal;

FIG. 9 is a chart showing timings of each signal when a processing task A and a processing task B are executed;

FIG. 10 is a chart showing timings of each signal when the abnormality detecting section 1 of the present invention monitors a processing task 120A and a processing task 120B shown in FIG. 3;

FIG. 11 is a block diagram showing an example of a configuration of an abnormality detecting section 1 that is a semiconductor integrated device according to a second embodiment of the present invention; and

FIG. 12 is a block diagram showing an example of a configuration of an abnormality detecting section 1 that is a semiconductor integrated device according to a third embodiment of the present invention.

### DESCRIPTION OF PREFERRED EMBODIMENTS

Hereinafter, semiconductor devices and abnormality detecting methods according to embodiments of the present invention will be described by referring to the accompanying drawings.

### First Embodiment

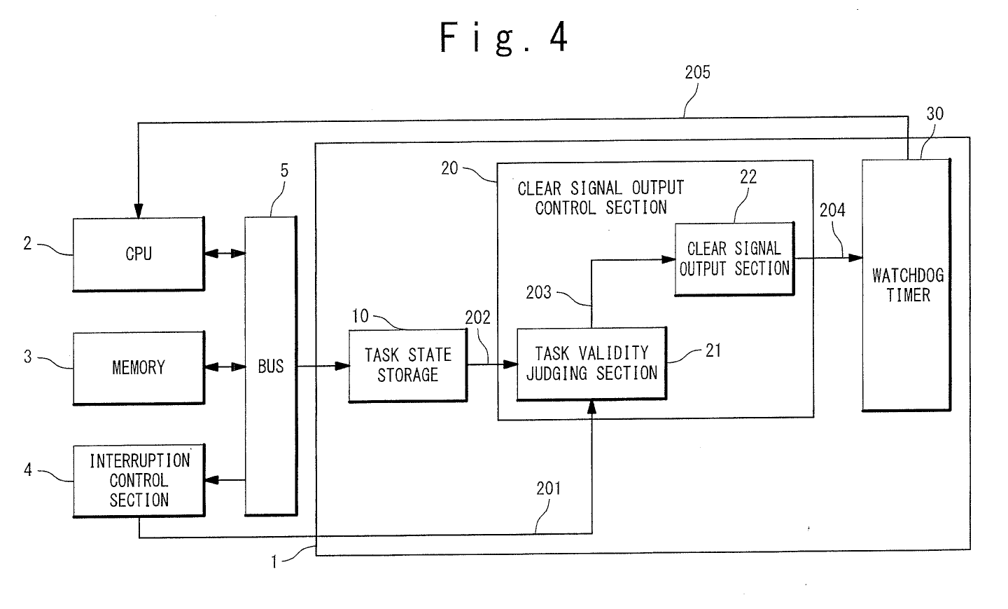

A semiconductor device and an abnormality detecting method will be described according to a first embodiment of the present invention. FIG. 4 is a block diagram showing an example of a configuration of an abnormality detecting section 1 that is a semiconductor integrated device according to the first embodiment of the present invention. Referring to FIG. 4, the abnormality detecting section 1 is connected to a bus 5, and a CPU (Central Processing Unit) 2, a memory 3, and an interruption control section 4 are connected to the bus 5. An input section for acquiring inputs of a user and an output section for having the user recognize a processing result may further be connected to the bus 5.

The CPU 2 executes software related to the present invention stored in the memory 3 to perform computing processing and control processing. The memory 3 is formed with a hard disk, a RAM (Random Access Memory), a ROM (Read Only Memory), or the like, which stores programs that implement each function and means related to the present invention and processing results of the CPU 2. The interruption control section 4 outputs an interruption signal 201 to the abnormality detecting section 1 based on the control of the CPU 2.

The abnormality detecting section 1 detects an abnormality of a processing task of the software executed by the CPU 2, and outputs a reset signal to the CPU 2 when detecting an occurrence of abnormality.

The abnormality detecting section 1 may be implemented by a single integrated circuit using a semiconductor or may be implemented as a semiconductor device including a semiconductor integrated circuit. The abnormality detecting section 1 includes a task state storage 10, a clear signal output control section 20, and a watchdog timer 30.

The task state storage 10 stores an execution state of the processing task provided from the CPU 2 via the bus 5, and outputs an execution state signal 202 showing that the processing task is being executed to the clear signal output control section 20.

The clear signal output control section 20 acquires the interruption signal 201 and the execution state signal 202, and outputs a clear signal 204 to the watchdog timer 30 when the processing task is executed validly. The clear signal output control section 20 includes a task validity judging section 21 and a clear signal output section 22.

The task validity judging section 21 acquires the interruption signal 201 outputted from the interruption control section 4 and the execution state signal 202 outputted from the task state storage 10, and judges whether or not the processing task is executed validly. More specifically, the task validity judging section 21 turns under an interruption accepting state upon acquiring the interruption signal 201, and judges that the processing task is being executed validly when acquiring the execution state signal 202 during a period of the interruption accepting state. The task validity judging section 21 stores the valid operation state of the processing task to a register within the task validity judging section 21, and outputs a valid signal 203 to the clear signal output section 22.

The clear signal output section 22 pulse-outputs the clear signal 204 to the watchdog timer 30 based on the execution state signal 202 and the valid signal 203. More specifically, the clear signal output section 22 pulse-outputs the clear signal 204 to the watchdog timer 30 when the clear signal output control section 20 acquires the execution state signal 202 or the clear signal output control section 20 becomes incapable of acquiring the acquired execution state signal 202 under a state where the valid signal 203 is being acquired.

The watchdog timer 30 counts the time. The watchdog timer 30 clears the timer count value to “0” when acquiring the clear signal 204 within a prescribed time. In the meantime, when the clear signal 204 cannot be acquired even after the prescribed time has passed, the value of the timer overflows. Thus, the watchdog timer 30 outputs a reset signal 205 to the CPU 2.

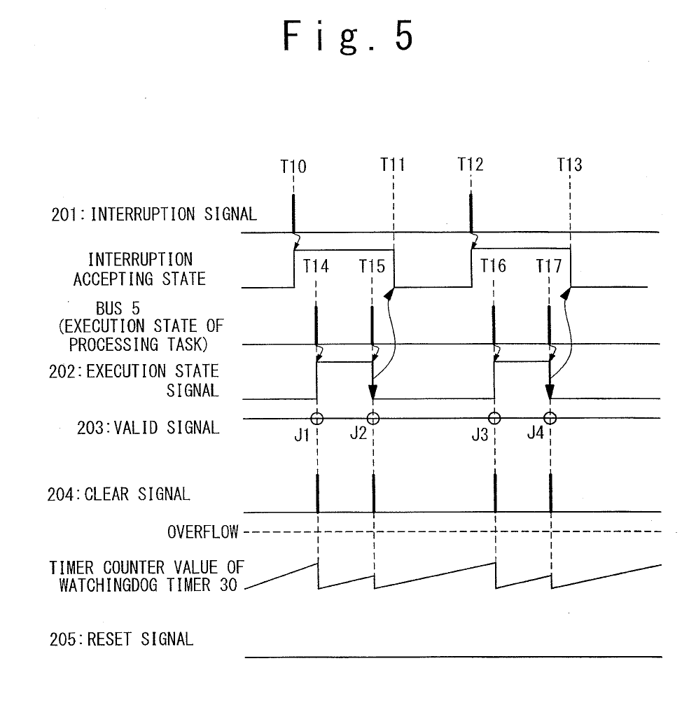

Processing operations will be described of the abnormality detecting section 1 according to the first embodiment of the present invention. FIG. 5 is a chart showing timing of each signal, when the processing task of the software executed by the CPU 2 is executed validly. Referring to FIG. 5, the processing operations will be described according to the first embodiment of the present invention.

Timing T10:

The interruption control section 4 outputs the interruption signal 201 to the task validity judging section 21 based on the control of the CPU 2. The task validity judging section 21 acquires the interruption signal 201, and turns under an interruption accepting state from timing T10.

Timing T14:

The CPU 2 outputs the execution state (start of execution) of the processing task stored in the memory 3 to the task state storage 10 via the bus 5. The task state storage 10 stores the execution state of the processing task provided from the CPU 2. Then, the task state storage 10 outputs the execution state signal 202 indicating that the processing task is being executed to the task validity judging section 21.

The task validity judging section 21 acquires the execution state signal 202 in the interruption accepting state, so that the task validity judging section 21 judges that the processing task is being executed validly. The task validity judging section 21 continuously outputs the valid signal 203 recorded as J1 to the clear signal output section 22.

When the clear signal output control section 20 has acquired the execution state signal 202 while acquiring the valid signal 203, the clear signal output section 22 pulse-outputs the clear signal 204 to the watchdog timer 30. The watchdog timer 30 clears the timer count value upon acquiring the clear signal 204.

Timing T15:

The CPU 2 outputs the execution state (end of execution) of the processing task to the task state storage 10 via the bus 5. The period from timing T14 to timing T15 is a period where the CPU 2 is executing the processing task. The task state storage 10 stores the execution state of the processing task provided by the CPU 2. The task state storage 10 does not output the execution state signal 202 from timing T15, since the execution of the processing task is ended.

Task validity judging section 21 judges that the processing task is ended validly, when the execution state signal 202 being acquired in the interruption accepting state becomes not acquired any more. The task validity judging section 21 continuously outputs the valid signal 203 recorded as J2 to the clear signal output section 22.

The clear signal output section 22 pulse-outputs the clear signal 204 to the watchdog timer 30 when the clear signal output control section 20 does not acquire the execution state signal any more while acquiring the valid signal 203. Upon acquiring the clear signal 204, the watchdog timer 30 clears the timer count value.

Timing T11:

The task validity judging section 21 cancels the interruption accepting state upon judging that the processing task is ended validly based on the execution state signal 202.

The processing from timing T12 to timing T13 shown in FIG. 5 is the same as the processing from timing T10 to timing T11 described above, so that explanations thereof are omitted. In the case shown in FIG. 5, the watchdog timer 30 acquires the clear signal 204 within a prescribed time and clears the timer count value, so that the CPU 2 can continue the execution of the processing task without acquiring the reset signal 205.

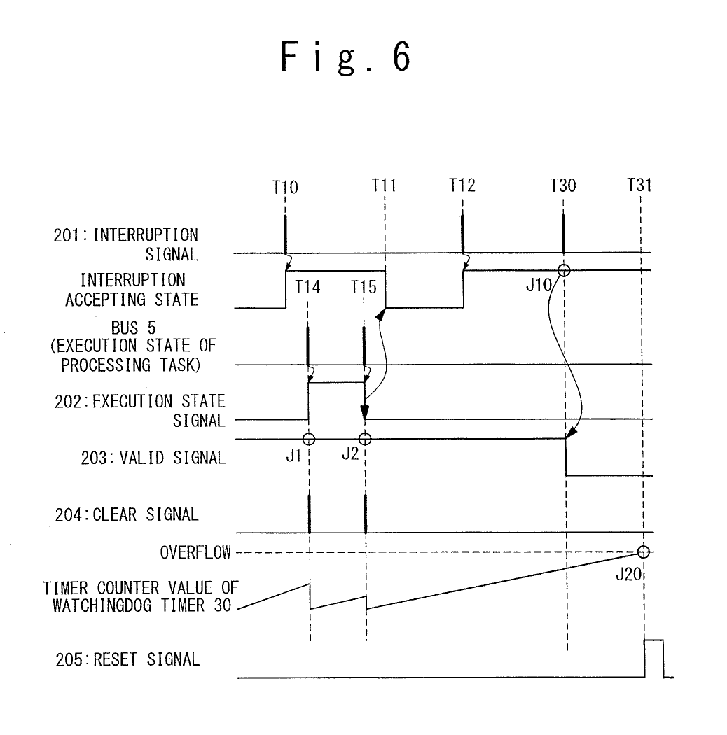

Next, processing operations will be described of the case where the abnormality detecting section 1 of the present invention detects an abnormality of the processing task. FIG. 6 is a chart showing timings of each signal when the processing task after the interruption signal 201 is not executed validly. The period from timing T10 to timing T11 in FIG. 6 is the period where the processing task is executed validly as in the case of FIG. 5, so that explanations thereof are omitted.

Timing T12:

The interruption control section 4 outputs the interruption signal 201 to the task validity judging section 21 based on the control of the CPU 2. The task validity judging section 21 turns under an interruption accepting state from timing T12 upon acquiring the interruption signal 201.

Timing T30:

The interruption control section 4 outputs the interruption signal 201 to the task validity judging section 21 based on the control of the CPU 2.

Since the task validity judging section 21 continuously acquires the interruption signal 201 without acquiring the execution state signal 202 in the interruption accepting state, the task validity judging section 21 does not output the valid signal 203. More specifically, after acquiring the interruption signal 201 at timing T12, the task validity judging section 21 judges that there is an occurrence of such abnormality that the processing task cannot be started due to malfunctioning of the program or the like at timing T30 based on the state of the register that stores the interruption accepting state shown in J10 and when the interruption signal 201 is continuously acquired before the task state signal 202 is inputted. Then, the task validity judging section 21 changes the register that stores the valid operation state of the processing task to an abnormal state, and does not output the valid signal 203 to the clear signal output section 22.

Timing T31:

Since the valid signal 203 cannot be acquired, the clear signal output section 22 does not pulse-output the clear signal 204 to the watchdog timer 30. The timer counter value overflows (J20) at timing T31, so that the watchdog timer 30 outputs the reset signal 205 to the CPU 2.

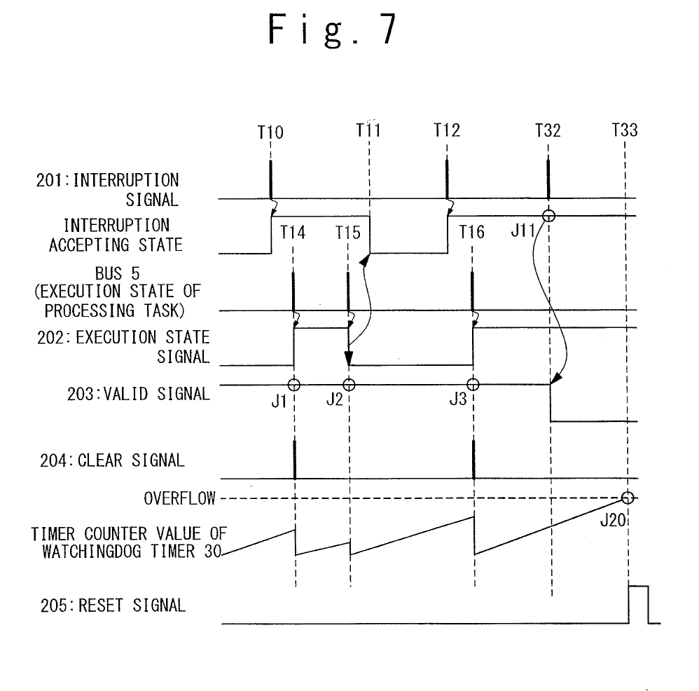

FIG. 7 is a chart showing timings of each signal when the processing task is not ended validly.

The period from timing T10 to timing T11 in FIG. 7 is the period where the processing task is executed validly as in the case of FIG. 5, so that explanations thereof are omitted.

Timing T12:

The interruption control section 4 outputs the interruption signal 201 to the task validity judging section 21 based on the control of the CPU 2. The task validity judging section 21 turns under an interruption accepting state from timing T12 upon acquiring the interruption signal 201.

Timing T16:

The CPU 2 outputs the execution state (start of execution) of the processing task stored in the memory 3 to the task state storage 10 via the bus 5. The task state storage 10 stores the execution state of the processing task provided from the CPU 2. Then, the task state storage 10 outputs the execution state signal 202 indicating that the processing task is being executed to the task validity judging section 21.

The task validity judging section 21 acquires the execution state signal 202 in the interruption accepting state, so that the task validity judging section 21 judges that the processing task is being executed validly. The task validity judging section 21 continuously outputs the valid signal 203 recorded as J3 to the clear signal output section 22.

When the clear signal output control section 20 has acquired the execution state signal 202 under the state while acquiring the valid signal 203, the clear signal output section 22 pulse-outputs the clear signal 204 to the watchdog timer 30. The watchdog timer 30 clears the timer count value upon acquiring the clear signal 204.

Timing T32:

The interruption control section 4 outputs the interruption signal 201 to the task validity judging section 21 based on the control of the CPU 2.

Since the task validity judging section 21 acquired the interruption signal 201 before the execution state signal 202 becomes not acquired any more in the interruption accepting state, the task validity judging section 21 does not output the valid signal 203. More specifically, the task validity judging section 21 judges that there is an occurrence of such abnormality that the processing task started at timing T16 cannot be ended due to malfunctioning of the program or the like at timing T32 based on the state of the register that stores the interruption accepting state shown in J11 and when the interruption signal 201 is continuously acquired before the task state signal 202 becomes not acquired any more in accordance with the termination of the execution of the processing task. Then, the task validity judging section 21 changes the register that stores the valid operation state of the processing task to an abnormal state at timing T32 where the occurrence of abnormality is judged, and does not output the valid signal 203 to the clear signal output section 22.

Timing T33:

Since the valid signal 203 cannot be acquired, the clear signal output section 22 does not pulse-output the clear signal 204 to the watchdog timer 30. The timer counter value overflows (J20), so that the watchdog timer 30 outputs the reset signal 205 to the CPU 2.

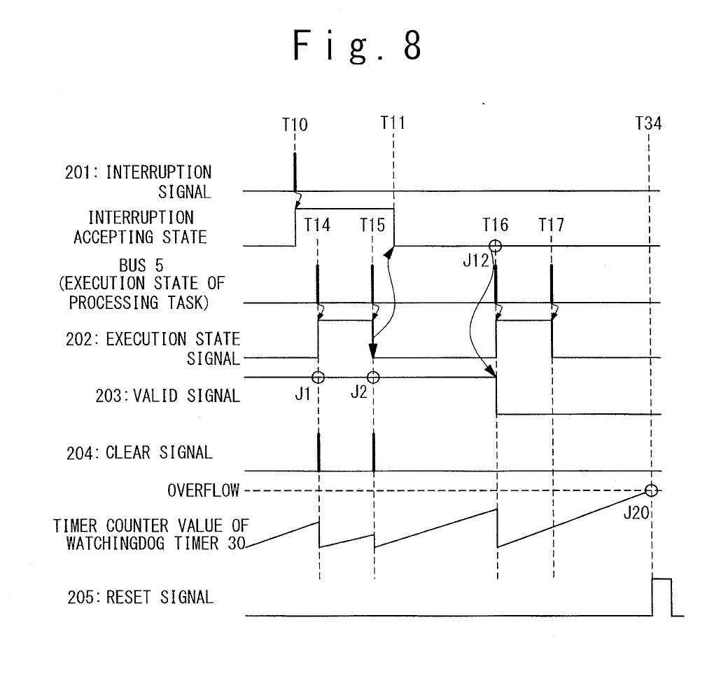

FIG. 8 is a chart showing timings of each signal when the processing task is started even though there is no interruption signal. The period from timing T10 to timing T11 in FIG. 8 is the period where the processing task is executed validly as in the case of FIG. 5, so that explanations thereof are omitted.

Timing T16:

The CPU 2 outputs the execution state (start of execution) of the processing task stored in the memory 3 to the task state storage 10 via the bus 5. The task state storage 10 stores the execution state of the processing task provided from the CPU 2. Then, the task state storage 10 outputs the execution state signal 202 indicating that the processing task is being executed to the task validity judging section 21.

Since the task validity judging section 21 acquired the interruption signal 201 during a period that is not under the interruption accepting state, the task validity judging section 21 judges that the processing task is not being executed validly. The task validity judging section 21 does not output the valid signal 203 to the clear signal output section 22. More specifically, the task validity judging section 21 judges that there is an occurrence of such abnormality that the processing task is started under a state where the interruption signal 201 is not acquired due to malfunctioning of the program or the like at timing T16 based on the state of the register that stores the interruption accepting state shown in J12 and when the interruption signal 202 indicating that the processing task is being executed is acquired. Then, the task validity judging section 21 changes the register that stores the valid operation state of the processing task to an abnormal state at timing T16 where the occurrence of abnormality is judged, and does not output the valid signal 203 to the clear signal output section 22.

Since the valid signal 203 cannot be acquired, the clear signal output section 22 does not pulse-output the clear signal 204 to the watchdog timer 30.

Timing T17:

The CPU 2 outputs the execution state (end of execution) of the processing task stored in the memory 3 to the task state storage 10 via the bus 5. The period from timing T16 to timing T17 is a period where the CPU 2 is executing the processing task. The task state storage 10 stores the execution state of the processing task provided from the CPU 2. Then, the task state storage 10 does not output the execution state signal 202 from timing T17 since the execution of the processing task is ended.

Timing T34:

The timer counter value overflows (J20), so that the watchdog timer 30 outputs the reset signal 205 to the CPU 2.

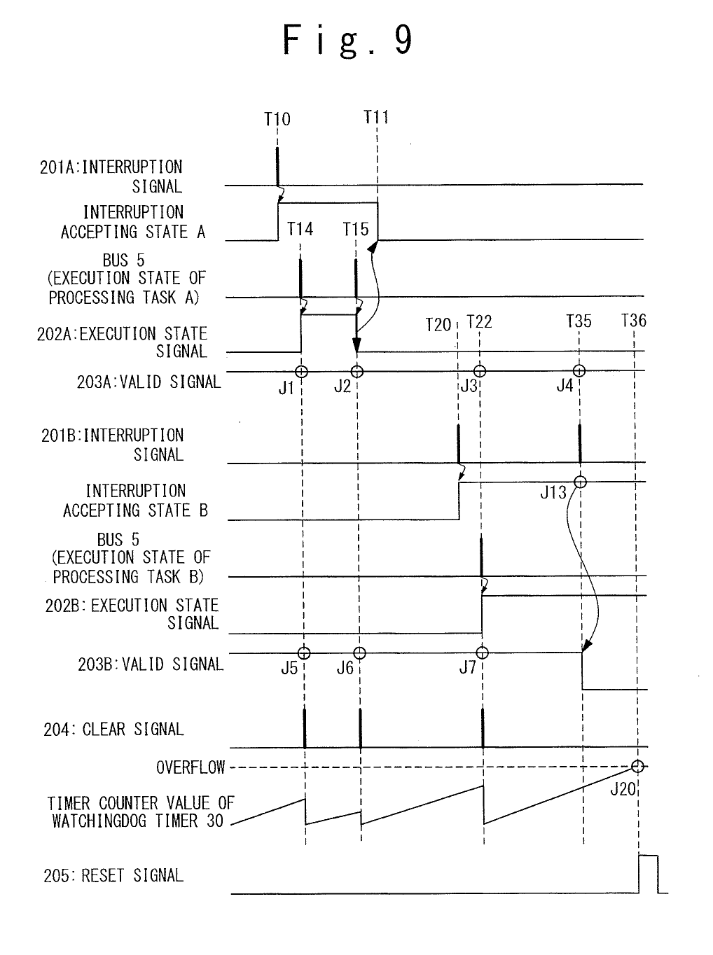

FIG. 9 is a chart showing timings of each signal when a processing task A and a processing task B are executed. The abnormality detecting section 1 includes the task state storage 10 and the task validity judging section 21 for each processing task. That is, the task state storage 10 can handle the execution state of the processing tasks acquired from the CPU 2 and the execution state signal 202 to be outputted for the processing task A and the processing task B separately. Similarly, the task validity judging section 21 can handle the interruption signal 201 acquired from the interruption control section 4, the interruption accepting state after acquiring the interruption signal, and the valid signal 203 for the processing task A and the processing task B separately. In FIG. 9, the period from timing T10 to timing T11 is the period where the processing task is executed validly as in the case of FIG. 5. Further, in FIG. 9, the period after timing T20 at which the processing task B is executed is a period where the processing task is not ended validly as in the case of FIG. 7.

Timing T10:

The interruption control section 4 outputs an interruption signal 201A to the task validity judging section 21 based on the control of the CPU 2. The task validity judging section 21 acquires the interruption signal 201A, and turns under an interruption accepting state A from timing T10.

Timing T14:

The CPU 2 outputs the execution state A (start of execution) of the processing task A stored in the memory 3 to the task state storage 10 via the bus 5. The task state storage 10 stores the execution state A of the processing task A provided from the CPU 2. Then, the task state storage 10 outputs an execution state signal 202A indicating that the processing task A is being executed to the task validity judging section 21.

The task validity judging section 21 acquires the execution state signal 202A in the interruption accepting state A, so that the task validity judging section 21 judges that the processing task A is being executed validly. The task validity judging section 21 continuously outputs a valid signal 203A recorded as J1 to the clear signal output section 22. Further, the task validity judging section 21 continuously outputs a valid signal 203B recorded as J5 to the clear signal output section 22.

When the valid signal 203B is acquired and when the clear signal output control section 20 has acquired the execution state signal 202A while acquiring the valid signal 203A, the clear signal output section 22 pulse-outputs the clear signal 204 to the watchdog timer 30. The watchdog timer 30 clears the timer count value upon acquiring the clear signal 204.

Timing T15:

The CPU 2 outputs the execution state (end of execution) of the processing task A to the task state storage 10 via the bus 5. The period from timing T14 to timing T15 is a period where the CPU 2 is executing the processing task A. The task state storage 10 stores the execution state of the processing task A provided by the CPU 2. The task state storage 10 does not output the execution state signal 202A from timing T15, since the execution of the processing task A is ended.

Task validity judging section 21 judges that the processing task A is ended validly, when the execution state signal 202A being acquired in the interruption accepting state A becomes not acquired any more. The task validity judging section 21 continuously outputs the valid signal 203A recorded as J2 to the clear signal output section 22. Further, the task validity judging section 21 continuously outputs the valid signal 203B recorded as J6 to the clear signal output section 22.

The clear signal output section 22 pulse-outputs the clear signal 204 to the watchdog timer 30 when the valid signal 203 is acquired and when the clear signal output control section 20 does not acquire the execution state signal any more while acquiring the valid signal 203. Upon acquiring the clear signal 204, the watchdog timer 30 clears the timer count value.

Timing T11:

The task validity judging section 21 cancels the interruption accepting state A upon judging that the processing task is ended validly based on the execution state signal 202A.

Timing T20:

The interruption control section 4 outputs the interruption signal 201B to the task validity judging section 21 based on the control of the CPU 2. The task validity judging section 21 turns under an interruption accepting state B from timing T20 upon acquiring the interruption signal 201B.

Timing T22:

The CPU 2 outputs the execution state B (start of execution) of the processing task B stored in the memory 3 to the task state storage 10 via the bus 5. The task state storage 10 stores the execution state B of the processing task B provided from the CPU 2. Then, the task state storage 10 outputs an execution state signal 202B indicating that the processing task B is being executed to the task validity judging section 21.

The task validity judging section 21 acquires the execution state signal 202B in the interruption accepting state B, so that the task validity judging section 21 judges that the processing task B is being executed validly. The task validity judging section 21 continuously outputs the valid signal 203B recorded as J7 to the clear signal output section 22. Further, the task validity judging section 21 continuously outputs the valid signal 203A recorded as J3 to the clear signal output section 22.

When the valid signal 203A is acquired and when the clear signal output control section 20 has acquired the execution state signal 202B while acquiring the valid signal 203B, the clear signal output section 22 pulse-outputs the clear signal 204 to the watchdog timer 30. The watchdog timer 30 clears the timer count value upon acquiring the clear signal 204.

Timing T35:

The interruption control section 4 outputs the interruption signal 201B to the task validity judging section 21 based on the control of the CPU 2.

Since the task validity judging section 21 acquired the interruption signal 201B before the execution state signal 202B becomes not acquired any more in the interruption accepting state, the task validity judging section 21 does not output the valid signal 203B. More specifically, the task validity judging section 21 judges that there is an occurrence of such abnormality that the processing task B started at timing T22 cannot be ended due to malfunctioning of the program or the like at timing T35 based on the state of the register that stores the interruption accepting state B shown in J13 and when the interruption signal 201B is continuously acquired before the task state signal 202B becomes not acquired any more in accordance with the termination of the execution of the processing task. Then, the task validity judging section 21 changes the register that stores the valid operation state of the processing task to an abnormal state at timing T35 where the occurrence of abnormality is judged, and does not output the valid signal 203B to the clear signal output section 22.

Timing T36:

Since the valid signal 203B cannot be acquired, the clear signal output section 22 does not pulse-output the clear signal 204 to the watchdog timer 30. The timer counter value overflows (J20), so that the watchdog timer 30 outputs the reset signal 205 to the CPU 2.

While FIG. 7 is quoted in FIG. 9 as an example of an abnormal operation, the abnormality detecting section 1 is also capable of detecting the abnormality when the processing task B is not started for the interruption signal 201B as in the case of FIG. 6 and when the processing task B is started in a state where there is no interruption signal 201B as in the case of FIG. 8.

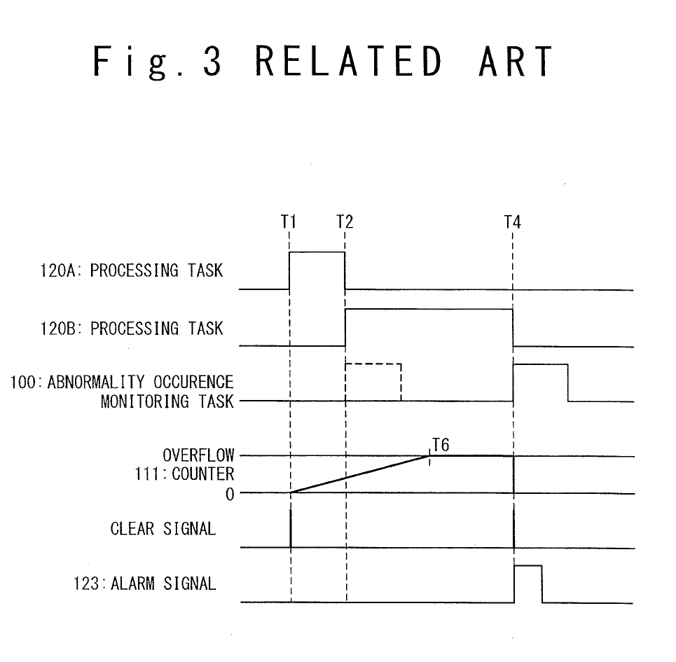

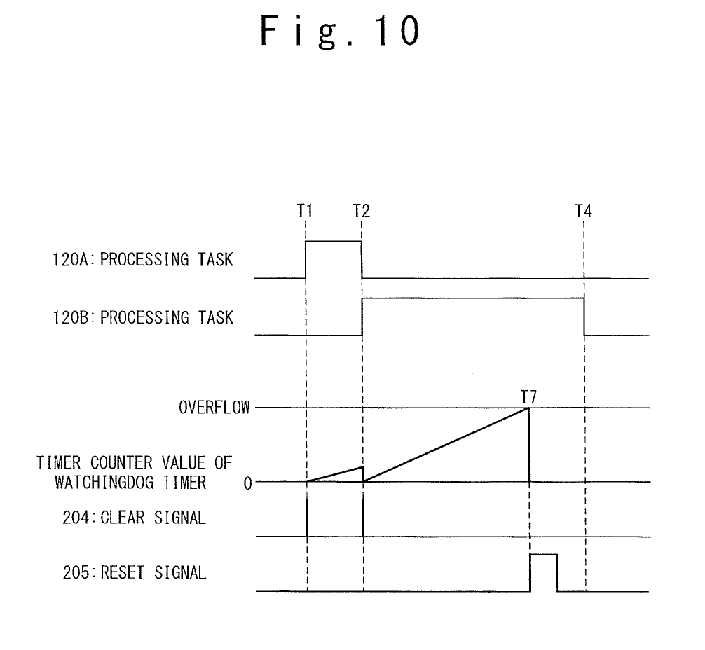

FIG. 10 is a chart showing timings of each signal when the abnormality detecting section 1 of the present invention monitors a processing task 120A and a processing task 120B shown in FIG. 3. As shown in FIG. 10, the abnormality detecting section 1 does not need to operate via the CPU 2, so that it is possible to securely detect such abnormality that the processing task 120B does not end as an abnormality at timing T7 where the watchdog timer 30 overflows.

As described above, the abnormality detecting section 1 as a semiconductor device according to the first embodiment of the present invention can judge whether or not the processing task of the software executed by the CPU 2 is executed validly, and can output the reset signal 205 to the CPU 2 from the watchdog timer when the processing task is not executed validly. This makes it possible to provide the effect of securely detecting the abnormality of the processing task without needing the CPU 2. Further, the abnormality detecting section 1 of the present invention provides the effect of speeding-up the response time for starting the task in response to an interruption request. This is because it is unnecessary to monitor the occurrence of abnormality with the software and becomes possible to execute the processing in response to the interruption request immediately, since the abnormality detecting section 1 can detect the abnormality without needing the CPU 2. Furthermore, the abnormality detecting section 1 of the present invention can omit the abnormality occurrence monitoring task such as the one depicted in Patent Literature 1, thereby providing the effect of reducing the load imposed upon the CPU 2. This is because it is unnecessary to monitor the occurrence of abnormality with the software and becomes possible to use the processing time for the time to execute another task, since the abnormality detecting section 1 can detect the abnormality without needing the CPU 2.

### Second Embodiment

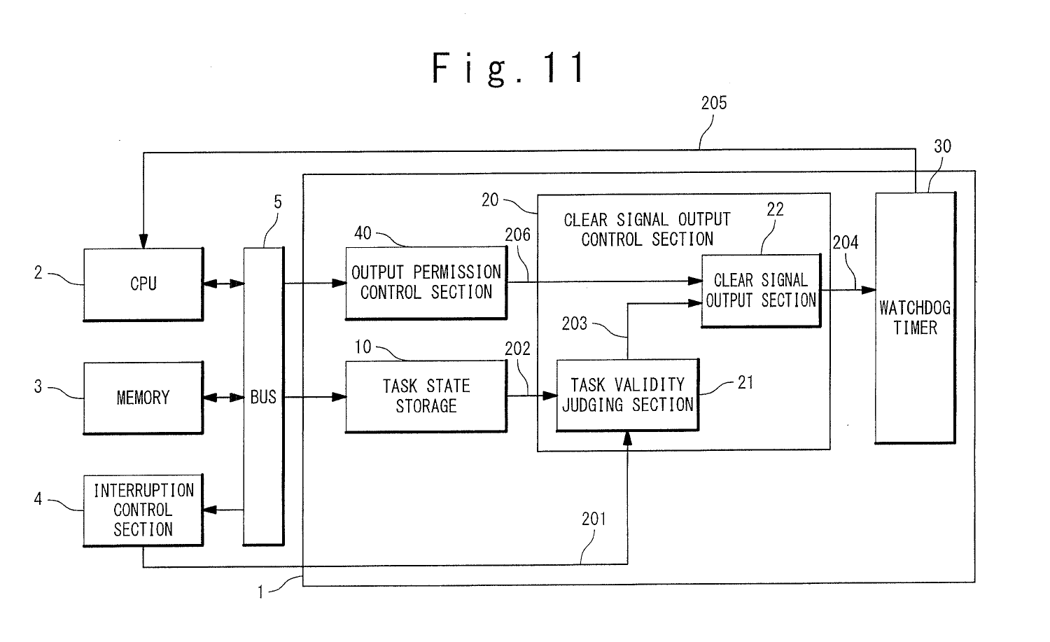

A semiconductor device and an abnormality detecting method will be described according to a second embodiment of the present invention. FIG. 11 is a block diagram showing an example of the structure of an abnormality detecting section 1 that is a semiconductor integrated device according to the second embodiment of the present invention. In the second embodiment of the present invention, the abnormality detecting section 1 includes an output permission control section 40 in addition to the configuration of the first embodiment. The abnormality detecting section 1 according to the second embodiment of the present invention is different from that of the first embodiment in respect that the clear signal output section 22 is capable of executing operations based on a clear permission signal 206 outputted from the output permission control section 40 by ignoring the valid signal 203 outputted from the task validity judging section 21. Other configurational components are the same as those of the first embodiment, so that explanations thereof are omitted by simply applying same reference numerals to the same configurational components.

The output permission control section 40 acquires a signal indicating a permission state or a non-permission state from the CPU 2, and records the permission state or the non-permission state to a register. The non-permission state indicates a state where the clear signal output section 22 ignores the valid signal 203. The permission state indicates a state where the clear signal output section 22 operates in the same manner as that of the first embodiment. The output permission control section 40 outputs the clear permission signal 206 indicating the non-permission state or the permission state to the clear signal output control section 20 based on the state of the register. That is, the abnormality detecting section 1 can control the clear signal output control section 20 whether or not to output the clear signal 204 to the watchdog timer 30 based on the clear permission signal 206 of the output permission control section 40.

The clear signal output section 22 acquires the clear permission signal 206 and the valid signal 203. The clear signal output section 22 can ignore the valid signal 203 from the task validity judging section 21 based on the clear permission signal 206. More specifically, when acquiring the clear permission signal 206 indicting the non-permission state, the clear signal output section 22 ignores the valid signal 203 that is outputted from the task validity judging section 21. In that case, the clear signal output section 22 pulse-outputs the clear signal 204 indicating the valid operation to the watchdog timer 30. When acquiring the clear permission signal 206 indicating the permission state, the clear signal output section 22 pulse-outputs the clear signal 204 when the valid signal 203 indicates the valid operation but does not pulse-output the clear signal 204 when the valid signal 203 indicates the abnormal operation.

The processing operations will be described of the abnormality detecting section 1 according to the second embodiment of the present invention. The output permission control section 40 acquires a signal indicating a permission state or a non-permission state from the CPU 2, and records the non-permission state or the permission state to the register.

The output permission control section 40 outputs the clear signal 206 indicating the non-permission state or the permission state to the clear signal output control section 20 based on the state of the register. The CPU 2 starts a processing task, and provides the execution state of the processing task to the task state storage 10.

The task state storage 10 acquires the execution state of the processing task, and outputs the execution state signal 202 to the task validity judging section 21. The task validity judging section 21 has acquired the execution state signal 202 in a period that is not under an interruption accepting state, so that the task validity judging section 21 does not output the valid signal 203.

When acquiring the clear permission signal 206 indicating the non-permission state, the clear signal output section 22 pulse-outputs the clear signal 204 to the watchdog timer 30 by ignoring the valid signal 203 that is outputted from the task validity judging section 21. Other operations are the same as those of the first embodiment, so that explanations thereof are omitted.

When the clear permission signal 206 outputted from the output permission control section 40 indicates the non-permission state, the abnormality detecting section 1 according to the second embodiment of the present invention is capable of controlling the clear signal output control section 20 to output the clear signal 204 to the watchdog timer 30 and not to output the reset signal 205 to the CPU 2 by ignoring the detected abnormality of the processing task. In the meantime, in a case where the clear permission signal 206 indicates the permission state, the abnormality detecting section 1 outputs the clear signal 204 when the clear signal output control section 20 detects the valid operation. When the abnormality is detected, the watchdog timer 30 can output the reset signal 205 to the CPU 2. That is, in a case where it is necessary with the software to start or end the tasks stored in the memory 3 in the order set in advance, the abnormality detecting section 1 according to the second embodiment of the present invention can temporarily halt the abnormality detecting function.

### Third Embodiment

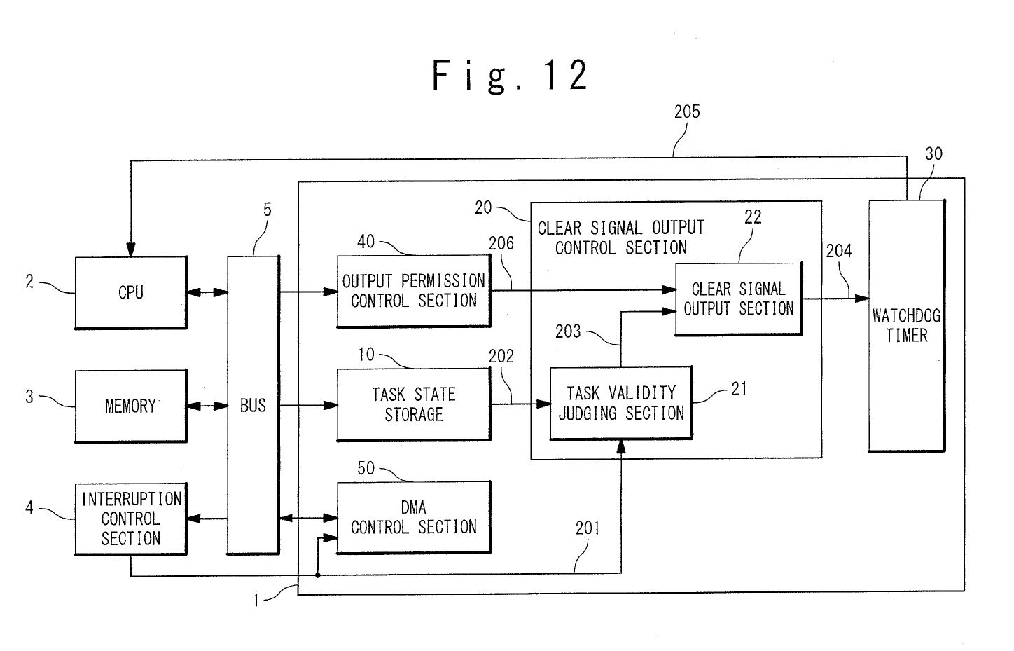

A semiconductor device and an abnormality detecting method will be described according to a third embodiment of the present invention. FIG. 12 is a block diagram showing an example of a configuration of the abnormality detecting section 1 that is a semiconductor integrated device according to the third embodiment of the present invention. In the third embodiment of the present invention, the abnormality detecting section 1 further includes a DMA (Direct Memory Access) control section 50 which is connected to the CPU 2 and the memory 3 via the bus 5. Other configurational components are the same as those of the second embodiment, so that explanations thereof are omitted by simply applying same reference numerals to the same configurational components.

The DMA control section 50 generates an address of the execution state of the processing task existing in the memory 3 based on a startup request provided from the CPU 2 or based on the interruption signal 201. Further, the DMA control section 50 acquires the execution state of the processing task from the memory 3, and provides it to the task state storage 10.

The abnormality detecting section 1 according to the third embodiment of the present invention provides such an effect that the software can concentrate on the task processing since it is unnecessary for the CPU 2 to access to the task state storage 10. Further, it becomes unnecessary with the abnormality detecting section 1 of the present invention to keep the execution states, the interruption accepting states, and the task valid operation states of the processing tasks stored in the register for the number of the all processing tasks that are operated simultaneously, so that the circuit scale can be reduced. It is because the DMA control section 50 transfers the execution states, the interruption accepting states, and the task valid operations states of the processing tasks recorded in the memory 3 to the register within the abnormality detecting section 1, so that it is unnecessary for the abnormal detecting section 1 to keep the execution states, the interruption accepting states, and the task valid operation states of the processing tasks for the all tasks started by the interruption signal 201 as the register. That is, the abnormality detecting section 1 according to the third embodiment of the present invention can reduce the registers that are prepared for all the tasks that are executed simultaneously, thereby providing the effect of reducing the circuit scale.

The embodiments of the present invention described above can be combined as necessary within a range that has no contradiction.

What is claimed is:

1. A semiconductor device comprising:
a task state storage configured to store an executing state of a processing task of software executed by a CPU and output an execution state signal to show the execution state of said processing task;
a task validity judging section configured to acquire an interruption signal corresponding to said processing task based to a control of said CPU and said execution state signal, and output a valid signal when said processing task is executed validly;
a clear signal output section configured to output a clear signal in response to said valid signal; and
a watchdog timer configured to clear a timer count value when said clear signal is acquired within a prescribed time and output a reset signal when said clear signal is not acquired within said prescribed time.

2. The semiconductor device according to claim 1 wherein said task validity judging section turns under an interruption accepting state upon acquiring said interruption signal and judges that said processing task is being executed validly when acquiring said execution state signal.

3. The semiconductor device according to claim 2 wherein said clear signal output section outputs said clear signal to said watchdog timer when said task validity judging section acquires said execution state signal or becomes incapable of acquiring said execution state signal under a state that said valid signal is being acquired.

4. The semiconductor device according to claim 3 further comprising:
an output permission control section configured to output a clear permission signal for controlling whether or not to output said clear signal to said watchdog timer.

5. The semiconductor device according to claims 4 further comprising:
a DMA (Direct Memory Access) control section configured to acquire an execution state of said processing task from a memory which is connected to said CPU via a bus, based on a startup request provided from said CPU or based on said interruption signal and provide the execution state of said processing task to said task state storage.

6. An abnormality detecting method comprising:
acquiring an interruption signal corresponding to a processing task of software executed by a CPU;
outputting an execution state signal to show an execution state of said processing task;
judging whether or not said processing task is being executed validly based on said interruption signal and said execution state signal;
outputting a valid signal when said processing task is executed validly;
outputting a clear signal in response to said valid signal;
judging whether or not said clear signal is acquired within a prescribed time;
clearing a timer count value of a watchdog timer when said clear signal is acquired within said prescribed time; and
outputting a reset signal to said CPU when said clear signal is not acquired within said prescribed time.

7. The abnormality detecting method according to claim 6 wherein said judging whether or not said processing task is being executed validly comprises:
turning under an interruption accepting state upon said interruption signal; and
judging that said processing task is being executed validly when acquiring said execution state signal under said interruption accepting state.

8. The abnormality detecting method according to claim 7 wherein said outputting a clear signal in response to said validly signal comprises:
outputting said clear signal to said watchdog timer when said execution state signal is acquired or said execution state signal becomes incapable of being acquired under a state where said valid signal is being acquired.

9. The abnormality detecting method according to claim 8 further comprising:
outputting a clear permission signal for controlling whether or not to output said clear signal wherein said outputting a clear signal in response to said valid signal further comprises:
ignoring said valid signal when acquiring said clear permission signal indicating a non-permission state.

10. The abnormality detecting method according to claim 9 wherein said outputting an execution state signal comprises:
acquiring an execution state of said processing task from a memory, connected to said CPU via a bus, based on a startup request provided from said CPU or based on said interruption signal and providing the execution state of said processing task.
